(19) United States
(12) Patent Application Publication
(10) Pub. No.: US 2024/0024768 A1
(43) Pub. Date: Jan. 25, 2024

(54) WIRELESS COMMUNICATION TERMINAL, INFORMATION PROCESSING DEVICE, AND INFORMATION PROCESSING METHOD

(71) Applicant: SONY GROUP CORPORATION, TOKYO (JP)

(72) Inventors: HIROMASA UCHIYAMA, TOKYO (JP); HIDEYUKI SUZUKI, TOKYO (JP); SHINICHIRO TSUDA, TOKYO (JP)

(21) Appl. No.: 18/042,294

(22) PCT Filed: Aug. 13, 2021
(86) PCT No.: PCT/JP2021/029788

§ 371 Date: Feb. 20, 2023

(30) Foreign Application Priority Data
Aug. 28, 2020 (JP) 2020-144520

(51) Int. Cl. A63F 13/355; H04W 28/18; A63F 13/77

(52) U.S. Cl. CPC A63F 13/355; H04W 28/18; A63F 13/77

(57) ABSTRACT

The present technology relates to a wireless communication terminal, an information processing device, and an information processing method that enable efficient use of communication resources in a case of playing a game using a mobile communication system. A wireless communication terminal according to one aspect of the present technology executes an application program of a game using a mobile communication system, transmits, during execution of the game, request information that is information indicating that a change of the experience quality of the game is requested to an information processing device that controls the quality of wireless communication provided by the mobile communication system, and changes a setting of the wireless communication on the basis of control information transmitted from the information processing device. The present technology can be applied to a device used for a cloud game.

### TECHNICAL FIELD

The present technology particularly relates to a wireless communication terminal, an information processing device, and an information processing method capable of efficiently using communication resources in a case of playing a game using a mobile communication system.

### BACKGROUND ART

As games for portable client terminals such as smartphones and the like, cloud games using position information of users have attracted attention. In the future, it is expected that new cloud games in which the real world and the virtual world are fused by utilizing 5G communication, augmented reality (AR) technology, and the like will become widespread.

In 5G communication, it is possible to flexibly and dynamically allocate communication resources including processing resources of a core network and calculation resources of an edge server to each user of cloud games by network virtualization.

### CITATION LIST

### Patent Document

Patent Document 1: Japanese Patent Application Laid-Open No. 2015-136127

### SUMMARY OF THE INVENTION

### Problems to be Solved by the Invention

It is difficult to recognize behavior of all users and allocate necessary communication resources to all users. That is, since the communication resources are limited, it is difficult to provide a cloud game that satisfies all users at the same time.

A mechanism for efficiently utilizing communication resources and providing necessary resources to users at necessary timing and at an allowable price is desired.

The present technology has been made in view of such a situation, and makes it possible to efficiently use communication resources in a case of playing a game using a mobile communication system.

### Solutions to Problems

A wireless communication terminal according to one aspect of the present technology includes: an execution unit that executes an application program of a game using a mobile communication system; and a control unit that transmits, to an information processing device that controls a quality of wireless communication provided by the mobile communication system, request information that is information indicating that a change in an experience quality of the game is requested during execution of the game, and changes a setting of the wireless communication on the basis of control information transmitted from the information processing device.

An information processing device according to another aspect of the present technology includes: a control unit that transmits first control information for giving an instruction on a change in a setting of wireless communication provided by a mobile communication system to a wireless communication terminal that executes an application program of a game using the mobile communication system in response to transmission of request information that is information indicating that a change in an experience quality of the game is requested from the wireless communication terminal during execution of the game, and transmits second control information for giving an instruction on a change in a setting of the wireless communication provided to the wireless communication terminal to a network device constituting the mobile communication system.

In one aspect of the present technology, an application program of a game using a mobile communication system is executed, request information that is information indicating that a change of an experience quality of the game is requested to an information processing device that controls quality of wireless communication provided by the mobile communication system is transmitted during execution of the game, and a setting of the wireless communication is changed on the basis of control information transmitted from the information processing device.

In another aspect of the present technology, first control information for giving an instruction on a change in a setting of wireless communication provided by a mobile communication system is transmitted to a wireless communication terminal that executes an application program of a game using the mobile communication system in response to transmission of request information that is information indicating that a change in an experience quality of the game is requested from the wireless communication terminal during execution of the game, and second control information for giving an instruction on a change in a setting of the wireless communication provided to the wireless communication terminal is transmitted to a network device constituting the mobile communication system.

### BRIEF DESCRIPTION OF DRAWINGS

FIG. 1 is a diagram illustrating a configuration example of a cloud game system according to an embodiment of the present technology.

FIG. 2 is a diagram illustrating an example of a management entity of each node.

FIG. 3 is a diagram illustrating a flow of service provision in the cloud game system.

FIG. 4 is another diagram illustrating a flow of service provision in the cloud game system.

FIG. 5 is a flowchart illustrating overall processing of the cloud game system.

FIG. 6 is a diagram illustrating an example of network status information and status notification information.

FIG. 7 is a diagram illustrating an example of UX request information.

FIG. 8 is a diagram illustrating an example of client status information.

FIG. 9 is a diagram illustrating an example of network control information and client control information.

FIG. 10 is a flowchart illustrating processing of a client terminal.

FIG. 11 is a diagram illustrating a display example of a UX-level selection screen.

FIG. 12 is a flowchart illustrating processing of a network infrastructure.

FIG. 13 is a flowchart illustrating processing of a control server.

FIG. 14 is a block diagram illustrating a configuration example of a client terminal.

FIG. 15 is a block diagram illustrating a functional configuration example of a client terminal.

FIG. 16 is a block diagram illustrating a configuration example of a control server.

FIG. 17 is a block diagram illustrating a functional configuration example of a control server.

### MODE FOR CARRYING OUT THE INVENTION

<<Outline of Present Technology>>

The present technology enables dynamic change of experience quality of a user regarding a game using a mobile communication system in response to a request from a client terminal used by the user. The change in the experience quality of the game is implemented, for example, by changing the setting of wireless communication on the client terminal side and the setting of wireless communication on the network infrastructure side providing the mobile communication system.

The request to change the experience quality of the game is made at any timing during the execution of the game, such as a timing at which a scene of the game is switched, a timing at which the purpose of the game is switched from the practice purpose to the actual play purpose, or the like. That is, the experience quality of one game dynamically changes depending on the timing.

The user can use the communication resources for realizing the experience quality desired by the user at a necessary timing.

Hereinafter, modes for carrying out the present technology will be described. The description will be given in the following order.
1. Cloud Game System
2. Processing of Entire Cloud Game System
3. Processing of Each Node
4. Configuration of Each Device
5. Specific Example of Communication Resource Control
6. Modifications

<<Cloud Game System>>

<Configuration of Cloud Game System>

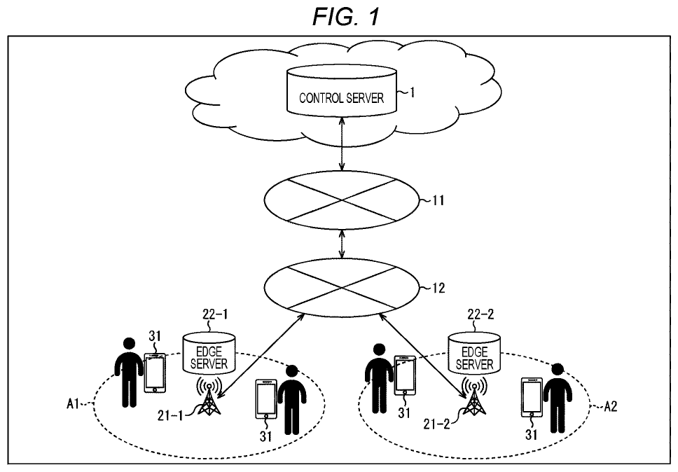

FIG. 1 is a diagram illustrating a configuration example of a cloud game system according to an embodiment of the present technology.

The cloud game system in FIG. 1 is an information processing system including a control server 1, radio base stations 21-1 and 21-2, edge servers 22-1 and 22-2, and a plurality of client terminals 31. Hereinafter, in a case where it is not necessary to distinguish the radio base station 21-1 and the radio base station 21-2 from each other, they are collectively referred to as a radio base station 21. Similarly, the edge server 22-1 and the edge server 22-2 are collectively referred to as an edge server 22 in a case where it is not necessary to distinguish the edge servers.

The control server 1 is a server on the Internet 11. A cellular core network 12 is connected to the Internet 11, and the radio base station 21 and the edge server 22 are connected to the cellular core network 12. Communication between the control server 1 and, for example, a client terminal 31 in the communication area A1 is performed via the Internet 11, the cellular core network 12, and the radio base station 21-1.

The control server 1 is an information processing device having a game engine function, a rendering function, and an encoding function of a cloud game. The control server 1 is configured by implementing logical entities in devices constituting a public cloud.

For example, the control server 1 provides a cloud game to the user of the client terminal 31 by transmitting a game video obtained by rendering and displaying the game video on the client terminal 31. As described above, the cloud game is a game that proceeds by performing processing such as rendering of a game video or the like on the server side.

As will be described later, the control server 1 also has a function of controlling the game experience quality, which is the quality of the game experience in the client terminal 31, in response to a request from the client terminal 31, or the like. The function of controlling the game experience quality may be provided in the control server 1, and the function of providing a cloud game such as a game engine function or the like may be provided in another server.

The radio base station 21 is a base station for cellular wireless communication or wireless LAN communication. For example, the radio base station 21 provides a service of 5G communication, which is communication of the fifth generation mobile communication system, to the client terminal 31 in the communication area.

FIG. 1 illustrates a communication area A1 formed as a radio wave coverage of the radio base station 21-1 and a communication area A2 formed as a radio wave coverage of the radio base station 21-2. More radio base stations 21 are connected to the cellular core network 12, and communication areas are formed by the respective radio base stations 21.

The edge server 22 is a server that has some functions for providing a cloud game and is located near the client terminal 31. The edge server 22 is installed in, for example, the radio base station 21. The edge server 22-1 is installed in the radio base station 21-1, and the edge server 22-2 is installed in the radio base station 21-2.

The cellular core network 12, the radio base station 21, and the edge server 22 constitute a network infrastructure of the mobile communication system. The devices constituting the cellular core network 12, the radio base station 21, and the edge server 22 are network devices constituting the network infrastructure.

The network infrastructure includes a radio layer between the client terminal 31 and the radio base station 21, and the cellular core network 12 from the radio base station 21 to the Internet 11 which is an external network. Examples of the cellular core network 12 include a 5G core, an evolved packet core (EPC), and the like.

The client terminal 31 is a portable wireless communication terminal such as a smartphone, a tablet terminal, or the like. The client terminal 31 may be configured by another type of device. For example, the client terminal 31 may be configured by a TV or a PC, or the client terminal 31 may be configured by a device for XReality (XR) such as virtual reality (VR), augmented reality (AR), or the like.

The client terminal 31 may be configured by a relay node, a relay terminal, or the like. The client device serving as the relay station is mounted, for example, on a car. Various types of information are relayed from the relay station to, for example, an internal terminal.

A game application that is an application program of a cloud game using the mobile communication system is installed in the client terminal 31 configured by such a device.

The game application installed in the client terminal 31 is, for example, an application program of a game in which the user plays while moving using the position information of the client terminal 31. In conjunction with the movement of the user, the position of the user in the game space moves, and the game proceeds. The user can move his/her place in the game space by actually visiting various places with the client terminal 31 in a state in which the cloud game is activated, acquire a character or an item at each place of the movement destination, and participate in an event such as a battle with a monster or the like.

Here, a flow of providing a cloud game in the cloud game system of FIG. 1 will be described. The cloud game is started when the client terminal 31 accesses the control server 1.

For example, the control server 1 renders the game video on the basis of the game logic, and distributes the game video obtained by the rendering to the client terminal 31 as a video stream via the Internet 11, the cellular core network 12, and the radio base station 21.

The client terminal 31 decodes the video stream transmitted from the control server 1, and displays the game video obtained by the decoding on the display. The client terminal 31 detects various operations performed by the user who is a game player, and transmits an operation command indicating the content of the operation to the control server 1.

Transmission and reception of such information are performed between the control server 1 and the client terminal 31, whereby a cloud game is implemented. By using the client terminal 31 equipped with a wireless communication function such as 5G communication or the like, the user can access the control server 1 via the radio base station 21 and enjoy the cloud game even outdoors or the like.

<Flow of Service Provision>

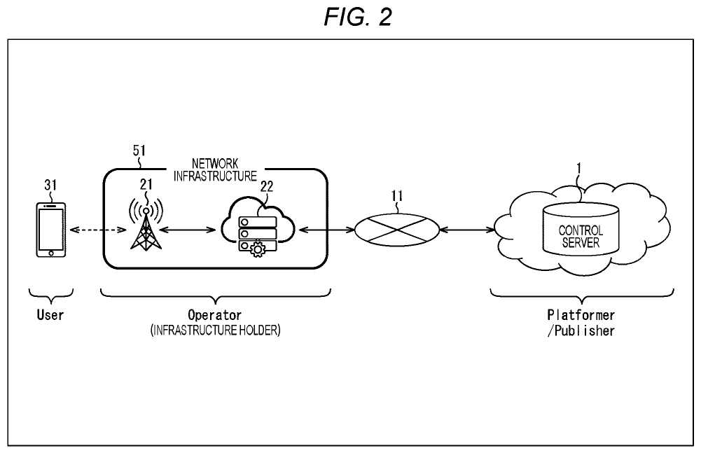

FIG. 2 is a diagram illustrating an example of a management entity of each node constituting the cloud game system.

The control server 1 is managed by, for example, a platformer which is a provider of an operating system (OS) installed on the client terminal 31 or a publisher which is a production company of a cloud game.

A network infrastructure 51 including the cellular core network 12, the radio base station 21, and the edge server 22 is managed by an operator such as a communication company or the like.

The client terminal 31 is managed by an end user of the cloud game.

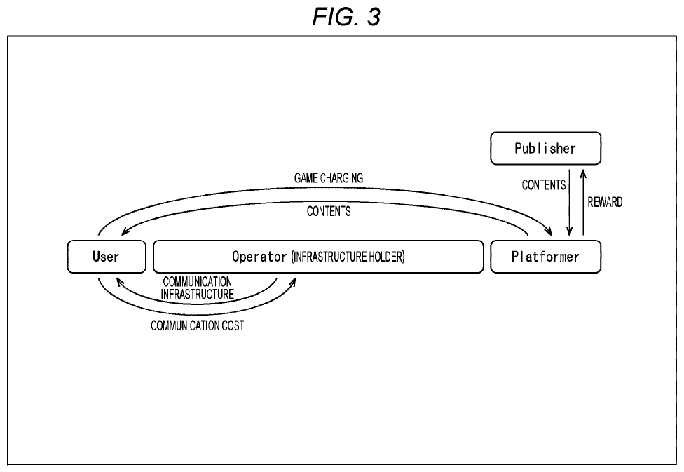

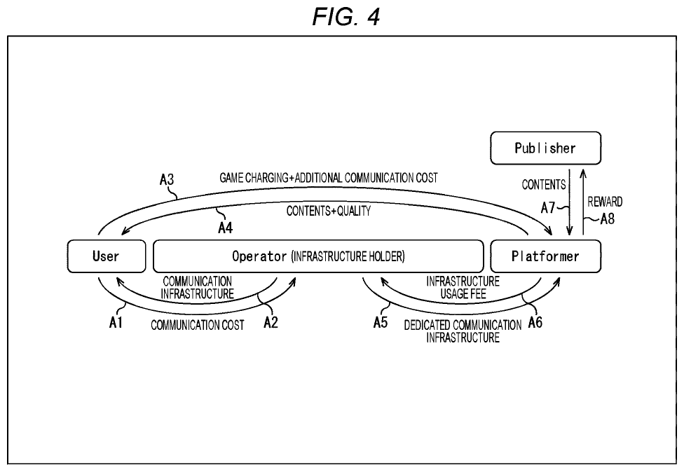

FIGS. 3 and 4 are diagrams illustrating a flow of service provision in the cloud game system.

The flow illustrated in FIG. 3 is a general (current) service provision flow, and the flow illustrated in FIG. 4 is a service provision flow in the cloud game system according to the present technology.

As illustrated in FIG. 3, in the current system, the user pays the communication cost to the operator and uses the mobile communication service provided by the operator. The user downloads content such as a game application or the like from the platformer using the mobile communication service, and charges as necessary.

The publisher provides content to the platformer and obtains a reward from the platformer. As described above, in the current system, the cloud game is operated without the mobile communication service and the game application cooperating with each other.

Meanwhile, in a future cloud game system, it is required that the mobile communication service and the game application cooperate with each other. This is because it is expected that it is difficult to provide communication of a quality that satisfies all users at the same time due to the limited communication resources although higher communication quality is required in the future cloud games as compared with the current games.

Therefore, a system is required in which a mobile communication service and a game application cooperate with each other and required communication resources are provided at a required timing and at an allowable price. In the cloud game system according to the present technology, such a system is realized.

In the cloud game system according to the present technology, as indicated by arrows A1 and A2 in FIG. 4, the user makes the same contract as the contract described with reference to FIG. 3 with the operator. Furthermore, the user makes a contract for using communication of a required quality with the platformer at any time.

In this case, as indicated by an arrow A3, the user pays an additional communication cost for using communication of a required quality to the platformer. The platformer provides the user with communication of a quality according to the communication cost as indicated by an arrow A4. As indicated by arrows A5 and A6, the platformer and the operator need to make a contract for the infrastructure usage fee and the communication infrastructure provision in advance.

The communication resources on the network infrastructure 51 side greatly change depending on location, time, and the like. For this reason, the infrastructure usage fee, the additional communication cost, and the like may be dynamically changed according to the tight situation of the communication resources on the network infrastructure 51 side. That is, the dynamic pricing regarding the communication cost can be performed according to the operation environment.

Note that, here, payment of an additional communication cost and provision of communication of a quality according to the communication cost are performed between the user and the platformer, but similar exchange may be performed between the user and the operator. In this case, the user pays an additional communication cost to the operator, and uses communication of a quality according to the communication cost provided by the operator.

In the cloud game, not only the communication resources on the network infrastructure 51 side but also the communication quality requested by the user dynamically changes. The communication quality requested by the user dynamically changes depending on, for example, the user attribute, the type of game being played, and the purpose of play (whether it is practice or actual play leading to evaluation of ranking, or the like).

In the cloud game system according to the present technology, the control of the communication quality is performed at a fine granularity according to a request from the user side, so that the game experience (user experience (UX)) of the user dynamically changes.

Details of processing for implementing the above operation will be described.

<<Processing of Entire Cloud Game System>>

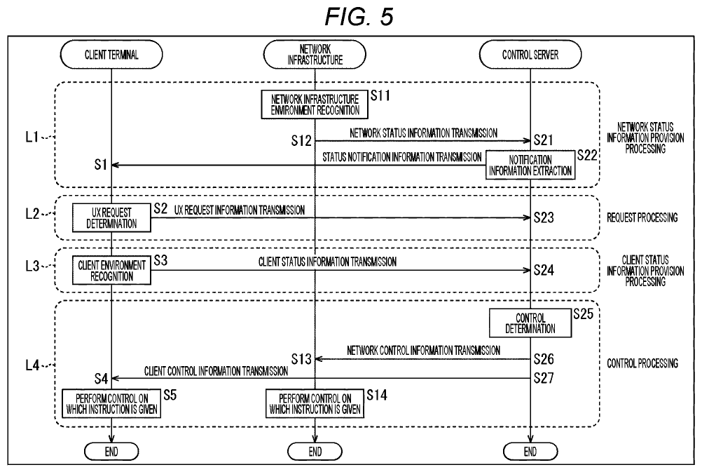

The entire processing of the cloud game system will be described with reference to the flowchart of FIG. 5.

As indicated by broken lines L1 to L4, the entire processing of the cloud game system includes network status information provision processing, request processing, client status information provision processing, and control processing. Each processing will be described below.

<Network Status Information Provision Processing>

The network status information provision processing is processing in which the control server 1 collects network status information provided by the network infrastructure 51. The network status information is information representing the environment of the network infrastructure 51, such as communication capacity or the like. The control server 1 can perform appropriate control by grasping the environment of the network infrastructure 51 in real time on the basis of the status information.

In step S11, the network infrastructure 51 recognizes the environment of the network infrastructure 51. Note that the processing described as being performed by the network infrastructure 51 in FIG. 5 and the like is actually processing performed by the network devices constituting the network infrastructure 51.

That is, the processing of the network infrastructure 51 illustrated in FIG. 5 may be performed by the radio base station 21 or may be performed by the edge server 22. Furthermore, the processing of the network infrastructure 51 illustrated in FIG. 5 may be performed by devices constituting the cellular core network 12. The processing of the network infrastructure 51 may be performed by cooperation of the radio base station 21, the edge server 22, and the devices constituting the cellular core network 12.

In step S12, the network infrastructure 51 transmits network status information to the control server 1.

In step S21, the control server 1 receives the network status information transmitted from the network infrastructure 51.

In step S22, the control server 1 extracts information of which the client terminal 31 needs to be notified from the information included in the network status information. The control server 1 transmits status notification information generated on the basis of the extracted information to the client terminal 31.

In step S1, the client terminal 31 receives the status notification information transmitted from the control server 1.

The notification of the environment of the network infrastructure 51 enables the client terminal 31 to determine the UX level to be requested to the control server 1 in consideration of the environment of the network infrastructure 51. In other words, the client terminal 31 can change the UX request value according to the environment of the network infrastructure 51 notification of which is provided using the status notification information. The UX level request will be described later.

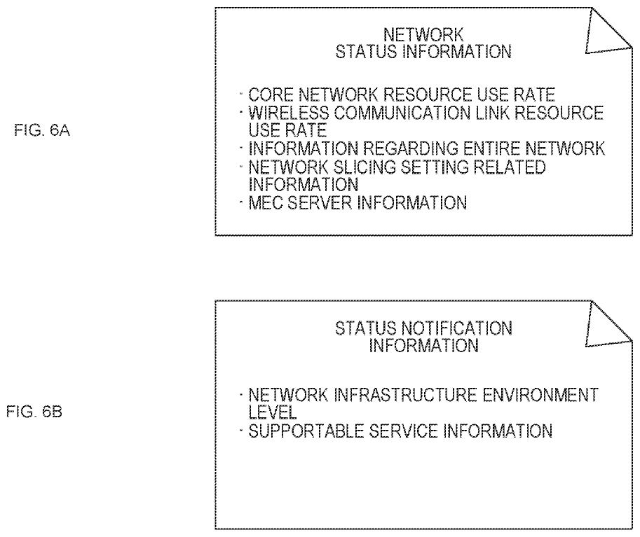

FIG. 6 is a diagram illustrating an example of the network status information and the status notification information.

As illustrated in A of FIG. 6, the parameters of the network status information include the following information.
Core network resource use rate
Wireless communication link resource use rate
Information regarding entire network
Network slicing setting related information
MEC server information

The information regarding the entire network includes, for example, capability information of the network infrastructure 51. The capability information of the network infrastructure 51 includes information serving as an index indicating how much communication capacity can be secured in the entire network infrastructure 51. For example, a level of 1 to 10 may be used as the index, or a reference such as a communication capacity or the like may be used.

The network slicing setting related information includes settable slice information, capability information in each slice, and the like. Note that network slicing is a technique for logically dividing configurations and resources according to characteristics of communication services and the like.

The settable slice information represents a settable slice, such as enhanced mobile broadband (eMBB), ultra reliable low latency communication (URLLC), massive machine type communication (mMTC), and the like.

Information regarding the slice setting set on the network infrastructure 51 side may be used as the settable slice information. For example, a slice using an identifier called single-network slice selection assistance information (S-NSSAI) is formed. S-NSSAI is commonly used among the client terminal 31, the RAN, and the core network (E2E network slicing). eMBB, mMTC, URLLC, and the like are defined as the service type (SST).

Capability information in each slice includes information indicating the number of terminals that can be accommodated, a feasible QoS, a delay budget, a feasible latency, a feasible throughput, a latency maximum jitter, and the like.

The multi-access edge computing (MEC) server information includes information indicating presence or absence of an MEC server that is the edge server 22, the number of available MEC servers, a calculation processing capability, and the like.

As described above, the network status information includes, as information indicating the environment of the network infrastructure 51, information that changes according to the current operation status together with information that does not change such as specifications and the like.

In the control server 1, predetermined information is extracted from the network status information, and status notification information is generated. By compressing the information obtained from the network infrastructure 51, it is possible to notify the client terminal 31 of the environment of the network infrastructure 51 using information of a limited data amount.

As illustrated in B of FIG. 6, the parameters of the status notification information include the following information.
Network infrastructure environment level
Supportable service information

The network infrastructure environment level is a level representing the environment of the network infrastructure 51. The environment of the network infrastructure 51 is represented by, for example, numerical values of 1 to 5. For example, the available communication quality varies depending on the network infrastructure environment level.

The supportable service information is information indicating which communication service the network infrastructure 51 can support. For example, game applications are classified according to the request levels of the communication quality, and communication services required by the game applications of each classification are defined.

The status notification information including such information is transmitted to the client terminal 31.

<Request Processing>

The request processing is processing in which the client terminal 31 requests the control server 1 to change the UX level. The UX level is a level representing the experience quality of the cloud game.

In step S2 of FIG. 5, the client terminal 31 determines the UX level to be requested as the experience quality of the cloud game being executed. Furthermore, the client terminal 31 transmits UX request information, which is information used for a request for changing the UX level, to the control server 1.

The UX level requested to the control server 1 is determined in consideration of the content of the status notification information provided from the control server 1. For example, the UX level that can be implemented within the range of the communication quality that can be provided by the network infrastructure 51 is determined. The communication quality that can be provided by the network infrastructure 51 is represented by the network infrastructure environment level. The UX level may be directly designated by the user, or may be automatically determined by the game application regardless of the designation by the user.

The UX level may be determined in consideration of not only the status notification information but also content of client status information to be described later. In this case, the client terminal 31 determines the UX level using the status notification information and the client status information.

In step S23, the control server 1 receives the UX request information transmitted from the client terminal 31.

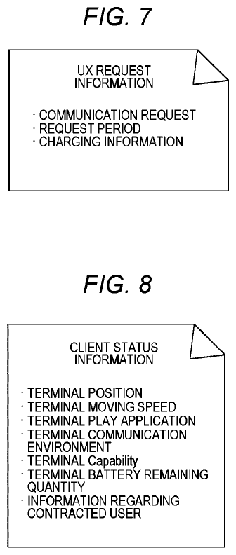

FIG. 7 is a diagram illustrating an example of the UX request information.

The parameters of the UX request information include the following information.
Communication request
Request period
Charging information

The communication request is information indicating the communication quality requested by the client terminal 31. The communication quality is represented by, for example, a throughput, an error rate, a latency amount, a used bandwidth, and the like. The error rate is represented by a packet error rate (PER), a block error rate (BLER), a bit error rate (BER), or the like, and the latency amount is represented by a latency, packet delay budget, or the like.

The request period is information indicating a period in which the communication quality is requested to be changed. The request period represents a start time, an end time, a period, an offset until the start of communication, and the like.

The charging information is information regarding charging for using communication of a required quality. For example, a charge amount corresponding to the contents of the communication request and the request period is set. The additional communication cost described with reference to FIG. 3 is paid according to the charging information.

The contents of the communication request and the request period are determined using, for example, a UX-level selection screen displayed as a game screen by the game application during execution of the cloud game. One or more parameters configuring the communication request and the request period are associated with each UX level. Each UX level is defined by combining one or more parameters configuring the communication request and the request period.

On the UX-level selection screen, for example, information on the amount of money in a case where each content is selected is displayed together with the contents of the communication request and the request period. In the selection screen of the UX level, detailed information such as the communication request, the request period, and the like may be presented to the user, or only the UX level that can be said to be information obtained by superconceptualizing the information such as the communication request, the request period, and the like may be presented.

For example, five levels of levels 1 to 5 are presented to the user as the UX level. The user selects the UX level by pressing a button displayed on the selection screen or the like. The user can designate the communication quality and the content of the period to be requested to the control server 1 by selecting the level represented by the number.

The request processing as described above is performed at various timings such as the timing of switching the scene of the cloud game, the timing of switching the purpose of the cloud game, and the like, for example. The scene switching includes switching of characters, switching of stories, switching of set stages, and the like. The purpose switching includes switching from the practice purpose to the actual play purpose and the like.

In this case, during the execution of one cloud game, a request for allowing the game to proceed at a UX level different from the previous level is made. That is, in one cloud game, a request for changing the UX level is made at a fine granularity such as a scene unit or the like.

A request for changing the UX level may be made in units of games such that request processing is performed at a timing when the cloud game to be executed is switched from a certain game to another game. For example, the change of the UX level may be requested depending on the type of the cloud game such as changing to a higher UX level at the time of execution of a battle type cloud game such as a sports game, a fighting game, and the like.

<Client Status Information Provision Processing>

The client status information provision processing is processing in which the control server 1 collects client status information provided by the client terminal 31. The client status information is information indicating the environment of the client terminal 31.

In step S3 of FIG. 5, the client terminal 31 recognizes the environment of its own terminal and transmits client status information to the control server 1.

In step S24, the control server 1 receives the client status information transmitted from the client terminal 31.

The control server 1 can perform appropriate control by recognizing the environment of the client terminal 31 on the basis of the client status information. For example, in a case where the wireless environment of the client terminal 31 is an extremely congested environment and the communication quality requested by the client terminal 31 cannot be provided, the control server 1 can perform control such as guiding the user of the client terminal 31 to move to a place or the like.

FIG. 8 is a diagram illustrating an example of client status information.

The parameters of the client status information include the following information.
Terminal position
Terminal moving speed
Terminal play application
Terminal communication environment
Terminal capability
Terminal battery remaining quantity
Information regarding contracted user

The terminal play application is information indicating a game application being executed in the client terminal 31.

The terminal communication environment is information indicating a communication environment of the client terminal 31. The terminal communication environment includes information indicating the radio base station 21 as a connection destination, information indicating a congestion degree of a band, information indicating the number of accommodated terminals, information related to communication quality, and the like. The information related to the communication quality includes RARP, RSSI, RSRQ, SNR, SINR, and the like.

The terminal capability is information indicating the specification of the client terminal 31. The terminal capability includes information indicating the number of antennas, information indicating a UE category, information indicating a battery size, and the like.

The information regarding the contracted user includes information indicating attributes of the user such as a charging status, a charging ability, a financial balance, and the like, age, sex, residential place, and the like.

As described above, the client status information includes, as information indicating the environment of the client terminal 31, information that changes according to the current situation together with information that does not change such as specifications or the like.

<Control Processing>

The control processing is processing in which the control server 1 controls the client terminal 31 and the network infrastructure 51 on the basis of the network status information provided from the network infrastructure 51 and the client status information provided from the client terminal 31.

In step S25 of FIG. 5, the control server 1 determines the contents of control for implementing the UX level requested by the client terminal 31 on the basis of the network status information and the client status information. The contents of the control may be determined in consideration of requests from a plurality of client terminals 31.

In step S26, the control server 1 transmits network control information to the network infrastructure 51. The network control information is information indicating the contents of control of the network infrastructure 51.

In step S27, the control server 1 transmits the client control information to the client terminal 31. The client control information is information indicating the contents of control of the client terminal 31.

In step S13, the network infrastructure 51 receives the network control information transmitted from the control server 1.

In step S14, the network infrastructure 51 performs control on which an instruction is given by the control server 1 on the basis of the network control information.

In step S4, the client terminal 31 receives the client control information transmitted from the control server 1.

In step S5, the client terminal 31 performs control on which an instruction is given by the control server 1 on the basis of the client control information.

The control of the client terminal 31 may be individually performed for each client terminal 31 that requests the change of the UX level, or may be collectively performed for all the client terminals 31 existing in the same communication area. Furthermore, the control of the client terminal 31 may be performed for a plurality of client terminals 31 belonging to a preset group.

Similarly, the control of the network infrastructure 51 may be performed for a plurality of network devices or a communication area in which a plurality of network devices exists.

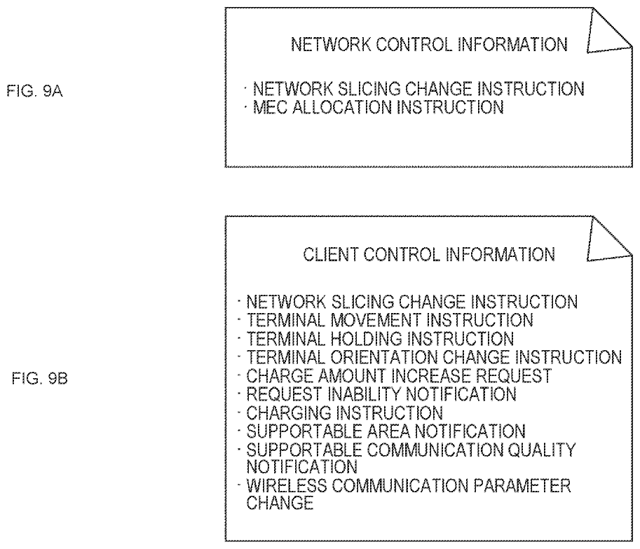

FIG. 9 is a diagram illustrating an example of the network control information and the client control information.

As illustrated in A of FIG. 9, the parameters of the network control information include the following information.
Network slicing change instruction
MEC allocation instruction

The network slicing change instruction is information for giving an instruction on a change in slice setting. An instruction on the change of the slice setting may be given using information such as a slice/service type (SST), a slice differentiator (SD), and the like.

The MEC allocation instruction is information for giving an instruction to allocate the calculation resource of the edge server 22 to implement the UX level requested by the client terminal 31.

In the network infrastructure 51, the setting related to the wireless communication to be provided to the client terminal 31 is changed on the basis of the network control information including such parameters.

As illustrated in B of FIG. 9, the parameters of the client control information include the following information.
Network slicing change instruction
Terminal movement instruction
Terminal holding instruction
Terminal orientation change instruction
Charge amount increase request
Request inability notification
Charging instruction
Supportable area notification
Supportable communication quality notification
Wireless communication parameter change

The network slicing change instruction is information for giving an instruction on a change in slice setting.

The terminal movement instruction is information for giving an instruction on movement of the communication area. On the basis of the terminal movement instruction, movement from the communication area of the currently connected radio base station 21 to the communication area of another radio base station 21 is presented to the user.

The terminal holding instruction is information for giving an instruction on how to hold the housing of the client terminal 31. On the basis of the terminal holding instruction, how to hold the housing such as the vertical or horizontal directions or the like is presented to the user.

The terminal orientation change instruction is information for giving an instruction on the orientation of the housing of the client terminal 31. The direction in which the housing is directed is presented to the user on the basis of the direction change instruction of the terminal.

The charge amount increase request is information for requesting an increase in additional communication cost.

The request inability notification is information for providing notification that the UX-level communication requested by the client terminal 31 cannot be provided.

The charging instruction is information for giving an instruction for charging of the battery of the client terminal 31.

The supportable area notification is information for providing notification of a communication area in which the UX level requested by the client terminal 31 can be implemented.

The supportable communication quality notification is information for providing notification of the UX level that can be implemented in the current communication area.

The wireless communication parameter change is information for giving an instruction on a change in parameters related to wireless communication. The wireless communication parameter change gives an instruction to change parameters related to wireless communication, such as modulation and coding set (MCS), transmission power, MIMO communication setting, and the like.

The change of the parameters related to the wireless communication changes the communication quality, thereby providing the cloud game at the UX level requested by the user.

As described above, in the cloud game system, in response to a request from the client terminal 31, control for implementing the UX level requested by the client terminal 31 is performed for each of the network infrastructure 51 and the client terminal 31.

Through the above processing, the user of the client terminal 31 can be assigned the communication resources necessary for the user at a necessary timing.

That is, the user can change the UX level from the previous UX level at an arbitrary timing such as a scene switching timing or a purpose switching timing of the cloud game, or the like, and continue the game at the UX level after the change. The user can play the same cloud game at different UX levels.

Furthermore, the control server 1 can efficiently utilize the communication resources of the network infrastructure 51 by providing each user with communication of quality for implementing the UX level required by each user. Furthermore, by providing high-quality communication only when necessary, the control server 1 can provide such high-quality communication at a price acceptable to the user as compared with a case where high-quality communication is always provided.

<<Processing of Each Node>>

Next, operations of the client terminal 31, the network infrastructure 51, and the control server 1 will be described.

<Processing of Client Terminal>

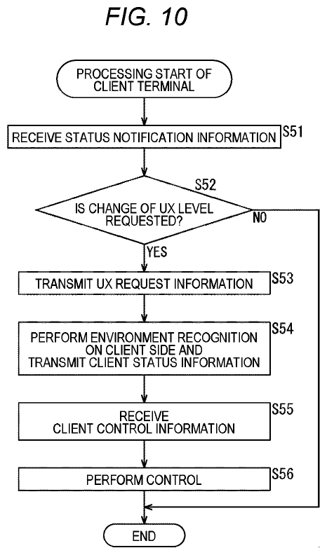

The processing of the client terminal 31 will be described with reference to the flowchart of FIG. 10.

In step S51, the client terminal 31 receives the status notification information transmitted from the control server 1.

By using the status notification information, the client terminal 31 can recognize the environment of the network infrastructure 51 to which its own terminal is connected, what kind of slicing setting communication line the network infrastructure 51 to which its own terminal is connected has, and the like. Notification of information such as the network capacity, the slicing capacity, and the like may be provided using the status notification information.

In step S52, the client terminal 31 judges whether or not the change of the UX level is requested. Information such as judging criteria used for judging whether or not to request a change of the UX level or the like may be provided from the network infrastructure 51 or the control server 1.

In a case where it is judged in step S52 that the change of the UX level is requested, in step S53, the client terminal 31 determines the requested UX level on the basis of the information from the game application or the like. The client terminal 31 transmits UX request information indicating the communication quality according to the determined UX level or the like to the control server 1.

As described above, for example, the UX level is directly designated by the user by the operation on the screen of the cloud game displayed by the game application. In a case where the user intends to change the UX level while playing the cloud game, the user performs a predetermined operation to display the selection screen of the UX level. Furthermore, the user operates a selection screen displayed as a screen of the cloud game, and selects a desired UX level from a plurality of UX levels.

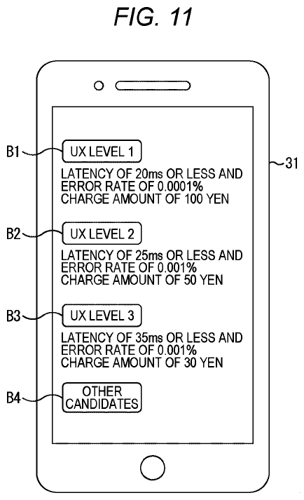

FIG. 11 is a diagram illustrating a display example of the UX level selection screen.

In the example of FIG. 11, selection buttons B1 to B3, which are buttons used to select the UX levels of the UX levels 1 to 3, are displayed. Under each button, information of the communication quality and the charge amount to be detailed description of each UX level is displayed.

The UX level 1 is a UX level defined by communication quality with the latency of 20 ms or less and an error rate of 0.0001%. The charge amount for the change to the UX level 1 is 100 yen.

The UX level 2 is a UX level defined by the communication quality of the latency of 25 ms or less and the error rate of 0.001%. The charge amount for the change to the UX level 2 is 50 yen.

The UX level 3 is a UX level defined by the communication quality of the latency of 35 ms or less and the error rate of 0.001%. The charge amount for the change to the UX level 3 is 30 yen.

An other candidate selection button B4 is displayed below the selection button B3. The other candidate selection button B4 is a button pressed when other UX levels are displayed in a case where the user is not satisfied with the UX levels or the amounts of money presented in the screen. In a case where the other candidate selection button B4 is pressed, information of different UX levels is displayed instead of the first displayed UX levels 1 to 3.

Using such a display, the user selects the UX level requested to the control server 1.

Returning to the description of FIG. 10, in step S54, the client terminal 31 performs environment recognition of its own terminal and transmits client status information to the control server 1.

Note that the timing of environment recognition on the client terminal 31 side may be designated by the control server 1 or the network infrastructure 51. The control server 1 or the network infrastructure 51 may notify the client terminal 31 of the measurement item and the measurement timing (measurement start time, measurement interval, measurement length, measurement end time, and the like).

In this case, the client terminal 31 measures the designated item at the timing notification of which is provided and reports the measured item to the control server 1 or the like. Not only the measurement timing but also the report timing may be designated.

In step S55, the client terminal 31 receives the client control information transmitted from the control server 1. An instruction on the contents of the control for implementing the requested UX level are given by the client control information.

In step S56, the client terminal 31 performs control based on the client control information by changing the setting of the wireless communication parameters or the like. After the control based on the client control information is performed, the process ends, and for example, the cloud game is continued at the UX level after the change.

Note that, in a case where it is judged in step S52 that the change of the UX level is not requested, the processing in steps S53 to S56 are skipped.

<Processing of Network Infrastructure 51>

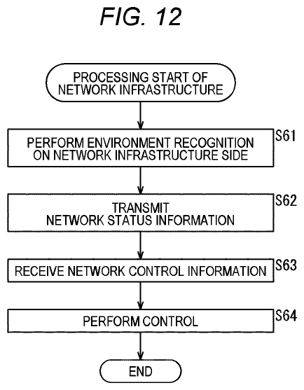

The processing of the network infrastructure 51 will be described with reference to the flowchart of FIG. 12.

In step S61, the network infrastructure 51 recognizes its own environment.

In step S62, the network infrastructure 51 transmits network status information to the control server 1.

Note that the control server 1 may designate the timing of environment recognition on the network infrastructure 51 side. The control server 1 may notify the network infrastructure 51 of the measurement item and the measurement timing (measurement start time, measurement interval, measurement length, measurement end time, and the like).

In this case, the network infrastructure 51 measures the designated item at the timing notification of which is provided and reports the measured item to the control server 1 or the like. Not only the measurement timing but also the report timing may be designated.

In step S63, the network infrastructure 51 receives the network control information transmitted from the control server 1. The contents of the control for implementing the UX level requested by the client terminal 31 are indicated by the network control information.

In step S64, the network infrastructure 51 performs control such as setting of communication parameters or the like on the basis of the network control information.

For example, as the setting for a specific client terminal 31 requesting the change of the UX level, control is performed such as performing new slicing setting, changing an existing slicing setting, and the like. According to the slicing setting, control such as allocation of calculating resources of the network infrastructure 51, resource control in the wireless access link, confirmation of whether or not the MEC can operate, or the like may be performed.

<Processing of Control Server>

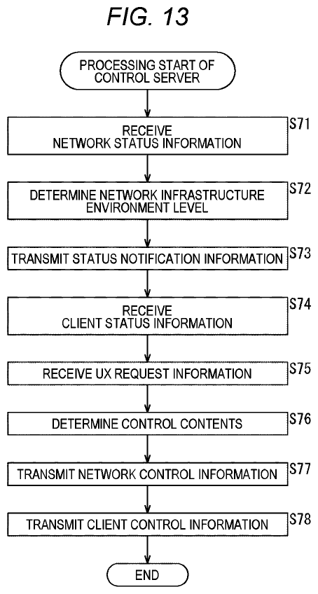

The processing of the control server 1 will be described with reference to the flowchart of FIG. 13.

In step S71, the control server 1 receives the network status information transmitted from the network infrastructure 51.

In step S72, the control server 1 determines the network infrastructure environment level on the basis of the information included in the network status information.

For example, the network infrastructure environment level of five stages is determined by quantifying how much there is a margin as the capacity of the network infrastructure 51 or quantifying the operable number of MEC. The network infrastructure environment level of 10 levels may be determined by quantifying the achievable latency amount and the like, or the network infrastructure environment level may be determined by combining a plurality of evaluation criteria.

In step S73, the control server 1 transmits status notification information including the determined network infrastructure environment level and the like to the client terminal 31.

In step S74, the control server 1 receives the client status information transmitted from the client terminal 31.

In step S75, the control server 1 receives the UX request information transmitted from the client terminal 31.

In step S76, the control server 1 determines the control contents of each of the client terminal 31 and the network infrastructure 51 on the basis of the UX request information. For example, the control contents for implementing the UX level requested by each of the client terminals 31 are determined on the basis of the UX request information transmitted from the plurality of client terminals.

The control contents are determined in consideration of, for example, the environment of the network infrastructure 51 notification of which is provided using the network status information and the environment of the client terminal 31 notification of which is provided using the client status information. That is, the communication quality to be provided to each client terminal 31 is determined within the range of the communication quality which can be provided by the network infrastructure 51 and can be supported by the client terminal 31, and the control contents for implementing the communication quality are determined. The charging information is also appropriately referred to in determining the control contents.

In step S77, the control server 1 notifies the network infrastructure 51 of the determined control contents by transmitting the network control information.

In step S78, the control server 1 notifies the client terminal 31 of the determined control contents by transmitting the client control information. Note that the UX level provided to the client terminal 31 may be updated after the control is performed.

<<Configuration of Each Device>>

Here, configurations of the control server 1 and the client terminal 31 that implement the above processing will be described.

<Configuration of Client Terminal 31>

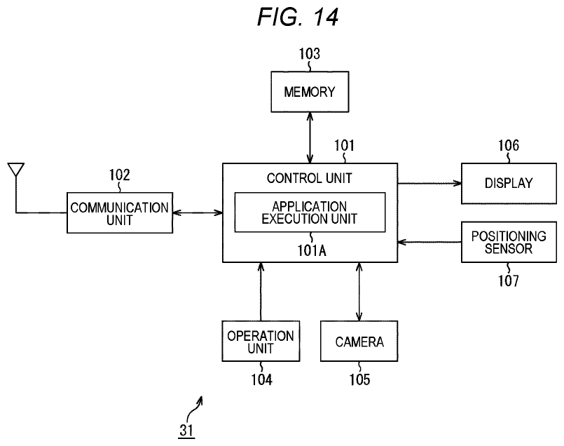

FIG. 14 is a block diagram illustrating a configuration example of the client terminal 31.

As illustrated in FIG. 14, the client terminal 31 is configured by connecting a communication unit 102, a memory 103, an operation unit 104, a camera 105, a display 106, and a positioning sensor 107 to the control unit 101.

The control unit 101 includes a CPU, a ROM, a RAM, and the like. The control unit 101 controls the entire operation of the client terminal 31 by executing a predetermined program.

In the control unit 101, an application execution unit 101A is implemented. Various applications such as a game application of a cloud game or the like are executed by the application execution unit 101A.

The communication unit 102 is a communication module corresponding to wireless communication of a mobile communication system such as 5G communication or the like. The communication unit 102 receives radio waves output from the radio base station 21 and communicates with various devices such as the control server 1 or the like via the radio base station 21 and the like. The communication unit 102 receives information transmitted from the control server 1 and outputs the information to the control unit 101. Furthermore, the communication unit 102 transmits the information supplied from the control unit 101 to the control server 1.

The memory 103 includes a flash memory or the like. The memory 103 stores various types of information such as an application executed by the control unit 101 or the like.

The operation unit 104 includes various buttons and a touch panel provided to overlap the display 106. The operation unit 104 outputs information indicating the content of the user's operation to the control unit 101.

The camera 105 captures an image according to an operation by a user.

The display 106 includes an organic EL display, an LCD, and the like. Various screens such as a screen of a cloud game or the like are displayed on the display 106.

The positioning sensor 107 includes a positioning sensor such as a GPS sensor and the like. The positioning sensor 107 outputs information indicating a positioning result of the position of the client terminal 31 to the control unit 101.

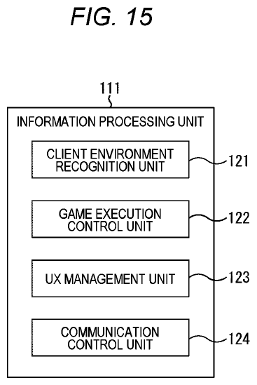

FIG. 15 is a block diagram illustrating a functional configuration example of the client terminal 31.

As illustrated in FIG. 15, an information processing unit 111 is implemented in the client terminal 31. The information processing unit 111 includes a client environment recognition unit 121, a game execution control unit 122, a UX management unit 123, and a communication control unit 124. At least a part of the functional units illustrated in FIG. 15 is implemented by execution of a game application by the application execution unit 101A in FIG. 14.

The client environment recognition unit 121 performs environment recognition on the client terminal 31 side, and generates client status information including a result of the environment recognition. The client status information generated by the client environment recognition unit 121 is output to the communication control unit 124. The environment recognition in step S3 of FIG. 5 is processing performed by the client environment recognition unit 121.

The game execution control unit 122 controls the progress of the cloud game. That is, the game execution control unit 122 acquires the game video transmitted from the control server 1 and displays the screen of the cloud game on the display 106. Furthermore, the game execution control unit 122 detects various operations performed by the user and generates an operation command indicating the content of the operation. The operation command generated by the game execution control unit 122 is output to the communication control unit 124.

The UX management unit 123 determines the UX level to be requested to the control server 1 on the basis of an operation by the user or the like, and generates the UX request information. The UX request information generated by the UX management unit 123 is output to the communication control unit 124. The determination of the request content in step S2 of FIG. 5 is processing performed by the UX management unit 123.

Furthermore, the UX management unit 123 changes the setting of the wireless communication parameters or the like on the basis of the client control information transmitted from the control server 1, and controls the UX level.

The communication control unit 124 controls the communication unit 102 to communicate with the control server 1 and transmits and receives various types of information. For example, the communication control unit 124 receives the game video transmitted from the control server 1 and outputs the game video to the game execution control unit 122. Furthermore, the communication control unit 124 transmits the operation command generated by the game execution control unit 122 to the control server 1.

The communication control unit 124 transmits the client status information generated by the client environment recognition unit 121 and the UX request information generated by the UX management unit 123 to the control server 1. The transmission of the UX request information in step S2 of FIG. 5 and the transmission of the client status information in step S3 are processing performed by the communication control unit 124.

Furthermore, the communication control unit 124 receives the status notification information and the client control information transmitted from the control server 1. The processing in steps S1 and S4 in FIG. 5 is processing performed by the communication control unit 124.

<Configuration of Control Server>

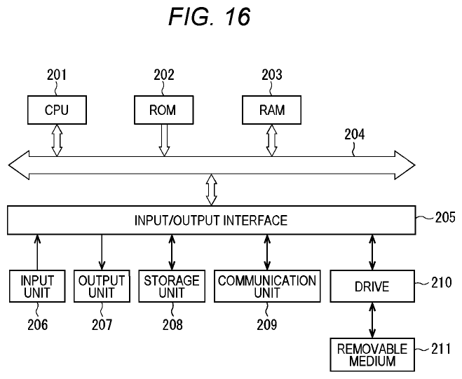

FIG. 16 is a block diagram illustrating a configuration example of the control server 1.

The control server 1 is configured by a computer. The control server 1 may include one computer having the configuration illustrated in FIG. 16 or may include a plurality of computers.

A CPU 201, a ROM 202, and a RAM 203 are connected to one another by a bus 204.

An input/output interface 205 is further connected to the bus 204. An input unit 206 including a keyboard, a mouse, and the like, and an output unit 207 including a display, a speaker, and the like are connected to the input/output interface 205. Furthermore, a storage unit 208 including a hard disk, a nonvolatile memory, and the like, a communication unit 209 including a network interface and the like, and a drive 210 that drives a removable medium 211 are connected to the input/output interface 205.

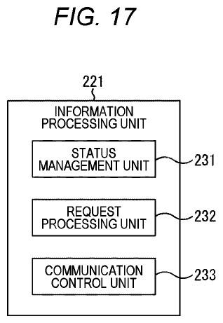

FIG. 17 is a block diagram illustrating a functional configuration example of the control server 1.

As illustrated in FIG. 17, an information processing unit 221 is implemented in the control server 1. The information processing unit 221 includes a status management unit 231, a request processing unit 232, and a communication control unit 233. At least a part of the functional units illustrated in FIG. 17 is implemented by executing a predetermined program by the CPU 201 in FIG. 16.

The status management unit 231 manages the environment of the network infrastructure 51 on the basis of the network status information transmitted from the network infrastructure 51.

Furthermore, the status management unit 231 generates status notification information for notifying the client terminal 31 of the environment of the network infrastructure 51 on the basis of the information included in the network status information. The status notification information generated by the status management unit 231 is output to the communication control unit 233. The generation of the status notification information in the processing of step S22 in FIG. 5 is processing performed by the status management unit 231.

The status management unit 231 manages the environment of the client terminal 31 on the basis of the client status information transmitted from the client terminal 31.

The request processing unit 232 performs processing for controlling the UX level of the client terminal 31 in response to a request for changing the UX level from the client terminal 31.

For example, the request processing unit 232 determines the control contents of each of the network infrastructure 51 and the client terminal 31 on the basis of the UX request information transmitted from the client terminal 31. The network control information and the client control information indicating the control contents determined by the request processing unit 232 are output to the communication control unit 233. The determination of the control contents in step S25 of FIG. 5 is processing performed by the request processing unit 232.

The communication control unit 233 controls the communication unit 209 to communicate with each of the client terminal 31 and the network infrastructure 51 and transmits and receives various types of information.

For example, the communication control unit 233 receives the client status information transmitted from the client terminal 31, and receives the UX request information transmitted from the client terminal 31. The processing in steps S23 and S24 in FIG. 5 is processing performed by the communication control unit 233.

Furthermore, the communication control unit 233 transmits the status notification information to the client terminal 31 and transmits the client control information to the client terminal 31. The transmission of the status notification information in step S22 and the transmission of the client control information in step S27 in FIG. 5 are processing performed by the communication control unit 233.

The communication control unit 233 receives the network status information transmitted from the network infrastructure 51 and transmits the network control information to the network infrastructure 51. The processing in step S21 of FIG. 5 and the transmission of the network control information in step S26 are processing performed by the communication control unit 233.

<<Specific Example of Communication Resource Control>>

Here, a specific example of control of communication resources in the cloud game system will be described.

<Example of Changing Setting of Network Slice>

Assumed Scenario
(1) A default communication line provided by the network infrastructure 51 is used by a user to practice a cloud game.
(2) Since a low latency and high reliability communication line is temporarily required to increase the ranking in the cloud game, the user temporarily secures such a communication line by charging.
(3) After a certain period of time, the user stops charging for the communication quality. The control server 1 returns the quality of the communication line to the original quality.

In this case, the network infrastructure 51 performs environment recognition. As a result of the environment recognition, the network infrastructure 51 recognizes that it is possible to provide URLLC slices, that the slices can provide 100 users per base station with highly reliable communication of delay and 0.001% error rate, and that the MEC server (edge server 22) is deployed. The network infrastructure 51 notifies the control server 1 of the results of the environment recognition using the network status information.

On the basis of the network status information, the control server 1 determines the support level (network infrastructure environment level) for low latency and highly reliable communication of the network infrastructure 51 as level 2, which is the second highest level among the five levels. The control server 1 provides the determined network infrastructure environment level to the client terminal 31 using the status notification information.

The client terminal 31 specifies that the network infrastructure environment level is level 2 on the basis of the status notification information. The client terminal 31 determines that there is no problem even if the UX request value is set to be high, and displays the three candidates of the UX levels in FIG. 11 on the screen of the cloud game. The candidate of the UX level presented to the user is determined on the basis of the network infrastructure environment level.

The user desires and selects UX level 3. Furthermore, the user selects 20 minutes as the valid period of the UX level 3.

The client terminal 31 transmits a communication request indicating a parameter such as a latency, an error rate, or the like associated with the UX level 3 and UX request information including a request period to the control server 1, and notifies the control server 1 of the UX request information as a UX request value.

Furthermore, the client terminal 31 performs environment recognition and transmits client status information to the control server 1. For example, the control server 1 is notified of the terminal position information by using the client status information.

The control server 1 determines the control contents on the basis of the UX request values from the plurality of client terminals 31 and the environment of the client terminal 31. The control server 1 transmits network control information to the network infrastructure 51 and transmits client control information to the client terminal 31, thereby providing notification of each control content.

For example, the network infrastructure 51 is instructed to increase the allocated frequency band of the radio base station 21 in a communication area exceeding 100 users per base station. Furthermore, the client terminal 31 is instructed to temporarily amplify the transmission power of the radio wave.

### Modifications

Three-stage charging courses may be displayed on the screen of the cloud game on the basis of notification that the network infrastructure environment level is level 2.

For example, the following information regarding each of the charging courses 1 to 3 is presented to the user.
Charging course 1: maximum latency 30 ms, implementation period 15 minutes, charge amount 200 yen
Charging course 2: maximum latency 50 ms, implementation period 15 minutes, charge amount 150 yen
Charging course 3: maximum latency 100 ms, implementation period 15 minutes, charge amount 100 yen

For such a presentation, the user can select any charging course and use a communication line with low latency and high reliability only for a certain period of time.

The respective values of the maximum latency, the implementation period, the charge amount, and the like vary depending on the network infrastructure environment level and the like notification of which is provided from the control server 1. For example, in an environment where network capacity is insufficient and communication of sufficient quality cannot be provided, a charge amount increases. Therefore, the number of users who intend to use communication lines with low latency and high reliability can be suppressed.

In a case where the user selects any charging course, the charge amount of the charging course selected by the user is included in the UX request information and provided in notification from the client terminal 31 to the control server 1.

The control server 1 determines the control contents on the basis of the UX request values from the plurality of client terminals 31 and the environment of the client terminal 31, and notifies the client terminal 31 of the control contents by transmitting the client control information.

Communication resources are preferentially allocated to users who have made a charge, and communication quality is secured. Meanwhile, a best effort type communication is provided to other users by using the remaining communication resources. A specific client terminal 31 is notified that the request of the UX-level is not accepted by the request inability notification of the client status information.

<Example of Instructing Client Terminal to Move Communication Area>

Assumed scenario
(1) A default communication line provided by the network infrastructure 51 is used by a user to practice a cloud game.
(2) Since a low latency and high reliability communication line is temporarily required to increase the ranking in the cloud game, the user requests the change of the UX level.
(3) Since the communication quality for implementing the requested UX level cannot be secured, the control server 1 notifies the client terminal 31 of the supportable area.

In this case, the network infrastructure 51 performs environment recognition. As a result of the environment recognition, the network infrastructure 51 recognizes that it is possible to provide URLLC slices, that the slices can provide 100 users per base station with highly reliable communication of 30 ms delay and 0.001% error rate, and that the MEC server is deployed. Furthermore, the network infrastructure 51 recognizes that a network in a specific communication area is congested and the degree of tightness is 80%. The network infrastructure 51 notifies the control server 1 of the results of the environment recognition using the network status information.

The control server 1 specifies that the network is congested on the basis of the network status information. The control server 1 determines the support level (network infrastructure environment level) of the low latency and highly reliable communication of the network infrastructure 51 to be level 4, which is the fourth highest level among the five levels.

In this example, from the viewpoint of reducing the communication overhead, the control server 1 does not provide the determined network infrastructure environment level to the client terminal 31. That is, the network infrastructure environment level may or may not be provided to the client terminal 31 by using the status notification information.

The client terminal 31 notifies the control server 1 of the request for the communication quality with the latency of 30 ms by using the UX request information in response to the fact that the status notification information related to the environment of the network infrastructure 51 is not transmitted.

Furthermore, the client terminal 31 performs environment recognition and transmits client status information to the control server 1. For example, the control server 1 is notified of the terminal position information, the connection destination base station information, and the RSRP information as the communication environment information by using the client status information.

The control server 1 determines the control contents on the basis of the UX request values from the plurality of client terminals 31 and the environment of the client terminal 31. The control server 1 transmits network control information to the network infrastructure 51 and transmits client control information to the client terminal 31, thereby providing notification of each control content.

For example, the control server 1 specifies that the communication quality of the 30 ms latency cannot be implemented in the communication area in which the client terminal 31 is currently located on the basis of the terminal position information, the connection destination base station information, and the RSRP information obtained from the client terminal 31. The control server 1 instructs the client terminal 31 to move to a neighboring communication area capable of implementing communication quality with a latency of 30 ms.

The client terminal 31 displays, on the screen of the cloud game, information on a neighboring communication area capable of implementing communication quality with a latency of 30 ms, and prompts the user to move to the neighboring communication area. After the user moves to the neighboring communication area and connects to the new radio base station 21, the client terminal 31 starts communication on the basis of the slicing setting on which an instruction is given by the control server 1 using the client control information.

### Modifications

Although the case of controlling the wireless communication at the time of execution of the game application has been described, the above-described control of the wireless communication can also be applied to control at the time of execution of various applications other than the game application.

The request to change the UX level may be made a plurality of times in one game.

Although the request for the change of the UX level is made according to the operation by the user, the change of the UX level may be automatically requested from the client terminal 31 to the control server 1 without depending on the user's operation. The user may be allowed to set the UX level change request timing in advance.

Example of Program

The above-described series of processing can be executed by hardware or software. In a case where the series of processing is executed by software, a program constituting the software is installed in a computer incorporated in dedicated hardware, a general-purpose personal computer, or the like.

The program to be installed is provided by being recorded in the removable medium 211 including an optical disk (compact disc-read only memory (CD-ROM), digital versatile disc (DVD), and the like), a semiconductor memory, or the like. Furthermore, the program may be provided via a wired or wireless transmission medium such as a local area network, the Internet, or digital broadcasting. The program can be installed in the ROM 202 or the storage unit 208 in advance.

The program executed by the computer may be a program in which processing is performed in time series in the order described in the present specification, or may be a program in which processing is performed in parallel or at necessary timing such as when a call is made or the like.

In the present specification, a system means a set of a plurality of components (devices, modules (parts), or the like), and it does not matter whether or not all the components are in the same housing. Therefore, a plurality of devices housed in separate housings and connected via a network and one device in which a plurality of modules is housed in one housing are both systems.

Note that the effects described in the present specification are merely examples and are not limited, and other effects may be provided.

The embodiments of the present technology are not limited to the above-described embodiments, and various modifications can be made without departing from the gist of the present technology.

For example, the present technology can have a configuration of cloud computing in which one function is shared and processed in cooperation by a plurality of devices via a network.

Furthermore, each step described in the above-described flowcharts can be executed by one device or can be shared and executed by a plurality of devices.

Moreover, in a case where a plurality of processes is included in one step, the plurality of processes included in the one step can be executed by one device or can be shared and executed by a plurality of devices.

Example of Combination of Configurations

The present technology can also have the following configurations.

(1)

A wireless communication terminal including:
an execution unit that executes an application program of a game using a mobile communication system; and
a control unit that transmits, to an information processing device that controls a quality of wireless communication provided by the mobile communication system, request information that is information indicating that a change in an experience quality of the game is requested during execution of the game, and changes a setting of the wireless communication on the basis of control information transmitted from the information processing device.

(2)

The wireless communication terminal according to (1),
in which the control unit transmits the request information including information indicating quality of the wireless communication according to a level of the experience quality of the game.

(3)

The wireless communication terminal according to (2),
in which the control unit transmits the request information in response to selection of the level predetermined by a user using a screen of the game.

(4)

The wireless communication terminal according to (2) or (3),
in which the control unit transmits the request information including information indicating a period in which change of the experience quality of the game is requested.

(5)

The wireless communication terminal according to any one of (2) to (4),
in which the control unit transmits the request information including information regarding charging of an amount of money according to the level.

(6)

The wireless communication terminal according to any one of (1) to (5), further including
a recognition unit that recognizes an environment of the wireless communication in an area where the wireless communication terminal is present,
in which the control unit changes the setting of the wireless communication on the basis of the control information including a parameter determined in the information processing device according to the environment of the wireless communication and an environment on the mobile communication system.

(7)

The wireless communication terminal according to any one of (1) to (6),
in which the control unit transmits the request information at a timing of switching a scene of the game.

(8)

An information processing method in which
a wireless communication terminal is configured to:
execute an application program of a game using a mobile communication system;
transmit, to an information processing device that controls quality of wireless communication provided by the mobile communication system, request information that is information indicating that a change in an experience quality of the game is requested during execution of the game; and
change a setting of the wireless communication on the basis of control information transmitted from the information processing device.

(9)

An information processing device including:
a control unit that transmits first control information for giving an instruction on a change in a setting of wireless communication provided by a mobile communication system to a wireless communication terminal that executes an application program of a game using the mobile communication system in response to transmission of request information that is information indicating that a change in an experience quality of the game is requested from the wireless communication terminal during execution of the game, and transmits second control information for giving an instruction on a change in a setting of the wireless communication provided to the wireless communication terminal to a network device constituting the mobile communication system.

(10)

The information processing device according to (9), further including
a management unit that manages an environment of the wireless communication in an area where the wireless communication terminal is present recognized by the wireless communication terminal and an environment of the mobile communication system recognized by the network device,
in which the control unit determines a content of an instruction to each of the wireless communication terminal and the network device according to the environment of the wireless communication and the environment on the mobile communication system.

(11)

The information processing device according to (9) or (10),
in which the request information includes information indicating a quality of the wireless communication according to a level of the experience quality of the game.

(12)

The information processing device according to (11),
the request information includes information indicating a period in which change of the experience quality of the game is requested.

(13)

The information processing device according to (11) or (12),
in which the request information includes information regarding charging of an amount of money according to the level.

(14)

An information processing method in which
an information processing device is configured to:
transmit first control information for giving an instruction on a change in a setting of wireless communication provided by a mobile communication system to a wireless communication terminal that executes an application program of a game using the mobile communication system in response to transmission of request information that is information indicating that a change in an experience quality of the game is requested from the wireless communication terminal during execution of the game; and
transmit second control information for giving an instruction on a change in a setting of the wireless communication provided to the wireless communication terminal to a network device constituting the mobile communication system.

### REFERENCE SIGNS LIST

1 Control server
21-1, 21-2 Radio base station
22-1, 22-2 Edge server
31 Client terminal
51 Network infrastructure
111 Information processing unit
121 Client environment recognition unit
122 Game execution control unit
123 UX management unit
124 Communication control unit
221 Information processing unit
231 Status management unit
232 Request processing unit
233 Communication control unit

1. A wireless communication terminal comprising:
an execution unit that executes an application program of a game using a mobile communication system; and
a control unit that transmits, to an information processing device that controls a quality of wireless communication provided by the mobile communication system, request information that is information indicating that a change in an experience quality of the game is requested during execution of the game, and changes a setting of the wireless communication on a basis of control information transmitted from the information processing device.

2. The wireless communication terminal according to claim 1,
wherein the control unit transmits the request information including information indicating quality of the wireless communication according to a level of the experience quality of the game.

3. The wireless communication terminal according to claim 2,
wherein the control unit transmits the request information in response to selection of the level predetermined by a user using a screen of the game.

4. The wireless communication terminal according to claim 1,
wherein the control unit transmits the request information including information indicating a period in which change of the experience quality of the game is requested.

5. The wireless communication terminal according to claim 2,
wherein the control unit transmits the request information including information regarding charging of an amount of money according to the level.

6. The wireless communication terminal according to claim 1, further comprising
a recognition unit that recognizes an environment of the wireless communication in an area where the wireless communication terminal is present,
wherein the control unit changes the setting of the wireless communication on a basis of the control information including a parameter determined in the information processing device according to the environment of the wireless communication and an environment on the mobile communication system.

7. The wireless communication terminal according to claim 1,
wherein the control unit transmits the request information at a timing of switching a scene of the game.

8. An information processing method in which
a wireless communication terminal is configured to:
execute an application program of a game using a mobile communication system;
transmit, to an information processing device that controls quality of wireless communication provided by the mobile communication system, request information that is information indicating that a change in an experience quality of the game is requested during execution of the game; and
change a setting of the wireless communication on a basis of control information transmitted from the information processing device.

9. An information processing device comprising:
a control unit that transmits first control information for giving an instruction on a change in a setting of wireless communication provided by a mobile communication system to a wireless communication terminal that executes an application program of a game using the mobile communication system in response to transmission of request information that is information indicating that a change in an experience quality of the game is requested from the wireless communication terminal during execution of the game, and transmits second control information for giving an instruction on a change in a setting of the wireless communication provided to the wireless communication terminal to a network device constituting the mobile communication system.

10. The information processing device according to claim 9, further comprising
a management unit that manages an environment of the wireless communication in an area where the wireless communication terminal is present recognized by the wireless communication terminal and an environment of the mobile communication system recognized by the network device,
wherein the control unit determines a content of an instruction to each of the wireless communication terminal and the network device according to the environment of the wireless communication and the environment on the mobile communication system.

11. The information processing device according to claim 9,
wherein the request information includes information indicating a quality of the wireless communication according to a level of the experience quality of the game.

12. The information processing device according to claim 9,
the request information includes information indicating a period in which change of the experience quality of the game is requested.

13. The information processing device according to claim 11,
wherein the request information includes information regarding charging of an amount of money according to the level.

14. An information processing method in which
an information processing device is configured to:
transmit first control information for giving an instruction on a change in a setting of wireless communication provided by a mobile communication system to a wireless communication terminal that executes an application program of a game using the mobile communication system in response to transmission of request information that is information indicating that a change in an experience quality of the game is requested from the wireless communication terminal during execution of the game; and
transmit second control information for giving an instruction on a change in a setting of the wireless communication provided to the wireless communication terminal to a network device constituting the mobile communication system.
